(19) United States
(12) Patent Application Publication
(10) Pub. No.: US 2026/0336680 A1
(43) Pub. Date: Oct. 29, 2026

(54) STROLLER

(71) Applicant: GOODBABY CHILD PRODUCTS CO., LTD., Kunshan (CN)

(72) Inventors: Wei Liu, Kunshan (CN); Defeng Yan, Kunshan (CN); Meng Zhang, Kunshan (CN)

(73) Assignee: GOODBABY CHILD PRODUCTS CO., LTD., Kunshan (CN)

(21) Appl. No.: 19/124,130

(22) PCT Filed: Nov. 29, 2022
(86) PCT No.: PCT/CN2022/135041

§ 371 Date: Apr. 24, 2025

(30) Foreign Application Priority Data
Oct. 28, 2022 (CN) 202211334976.3

(51) Int. Cl. B62B 7/10

(52) U.S. Cl. CPC B62B 7/105

(57) ABSTRACT

Disclosed is a stroller provided including: an underframe, an upper enclosure frame, and a folding mechanism used for driving the upper enclosure frame to move closer to or away from the underframe; the folding mechanism includes a first linkage assembly and a second linkage assembly, the first linkage assembly cooperates with the second linkage assembly, and when one of the first linkage assembly and the second linkage assembly moves, the other one thereof is driven to move synchronously, such that the upper enclosure frame performs an upward and downward translational motion relative to the underframe.

### CROSS-REFERENCE TO RELATED APPLICATIONS

This application is a national stage of International Application No. PCT/CN2022/135041, filed on Nov. 29, 2022, which claims priority to Chinese Patent Application No. 202211334976.3, filed on Oct. 28, 2022, both of which are hereby incorporated by reference in their entireties.

### TECHNICAL FIELD

The present disclosure relates to the field of children's products, and in particular to a stroller.

### BACKGROUND

Children's trailers can not only be used to carry children out, but also serve as a means of transporting goods, which has made the use of children's trailers increasingly widespread. For the convenience of carrying and storing children's trailers, they can generally be folded. A children's trailer generally includes an underframe and an upper enclosure frame arranged above the underframe, and when the children's trailer is unfolded for use, the upper enclosure frame moves away from the underframe, and when the children's trailer is folded, the upper enclosure frame is close to the underframe. In the conventional art, when the upper enclosure frame is folded or unfolded, the upper enclosure frame cannot always maintain translational motion, resulting in pulling problems in the cloth cover between the upper enclosure frame and the underframe, making the folding and unfolding actions of the upper enclosure frame not smooth, and also affecting the service life of the cloth cover.

### SUMMARY

The application provides a stroller, in which the upper enclosure frame always performs upward or downward translational motion when the stroller is folded or unfolded.

An aspect provides a stroller comprising an underframe and an upper enclosure frame located above the underframe, further comprises a folding mechanism arranged between the underframe and the upper enclosure frame and used for driving the upper enclosure frame to move closer to or away from the underframe, the folding mechanism comprises a first linkage assembly and a second linkage assembly, the first linkage assembly comprises a first upper link rod and a first lower link rod, wherein an upper end portion of the first upper link rod is rotatably connected to the upper enclosure frame, a lower end portion of the first lower link rod is rotatably connected to the underframe, and a lower end portion of the first upper link rod is rotatably connected to an upper end portion of the first lower link rod, the second linkage assembly comprises a second upper link rod and a second lower link rod, wherein an upper end portion of the second upper link rod is rotatably connected to the upper enclosure frame, a lower end portion of the second lower link rod is rotatably connected to the underframe, and a lower end portion of the second upper link rod is rotatably connected to an upper end portion of the second lower link rod, the first linkage assembly cooperates with the second linkage assembly, and when one of the first linkage assembly and the second linkage assembly moves, the other one thereof is driven to move synchronously, such that the upper enclosure frame performs upward or downward translational motion relative to the underframe.

In some embodiments, the first upper link rod cooperates with the second upper link rod.

Further, the first upper link rod comprises a first upper rod body and a first gear fixedly arranged at an upper end portion of the first upper rod body, the first gear is rotatably connected to the upper enclosure frame, a lower end portion of the first upper rod body is rotatably connected to the upper end portion of the first lower link rod, the second upper link rod comprises a second upper rod body and a second gear fixedly arranged at an upper end portion of the second upper rod body, the second gear is rotatably connected to the upper enclosure frame, a lower end portion of the second upper rod body is rotatably connected to the upper end portion of the second lower link rod, and the first gear meshes with the second gear.

In some embodiments, the first lower link rod cooperates with the second lower link rod.

Further, the first lower link rod comprises a first lower rod body and a third gear fixedly arranged at a lower end portion of the first lower rod body, the third gear is rotatably connected to the underframe, an upper end portion of the first lower rod body is rotatably connected to the lower end portion of the first upper link rod, the second lower link rod comprises a second lower rod body and a fourth gear fixedly arranged at a lower end portion of the second lower rod body, the fourth gear is rotatably connected to the underframe, an upper end portion of the second lower rod body is rotatably connected to the lower end portion of the second upper link rod, and the third gear meshes with the fourth gear.

In some embodiments, the first upper link rod cooperates with the second upper link rod, and the first lower link rod cooperates with the second lower link rod.

Further, the first upper link rod comprises a first upper rod body and a first gear fixedly arranged at an upper end portion of the first upper rod body, the second upper link rod comprises a second upper rod body and a second gear fixedly arranged at an upper end portion of the second upper rod body, the first lower link rod comprises a first lower rod body and a third gear fixedly arranged at a lower end portion of the first lower rod body, the second lower link rod comprises a second lower rod body and a fourth gear fixedly arranged at a lower end portion of the second lower rod body, both the first gear and the second gear are rotatably connected to the upper enclosure frame, both the third gear and the fourth gear are rotatably connected to the underframe, a lower end portion of the first upper rod body is rotatably connected to an upper end portion of the first lower rod body, a lower end portion of the second upper rod body is rotatably connected to an upper end portion of the second lower rod body, the first gear meshes with the second gear, and the third gear meshes with the fourth gear.

In some embodiments, the rotational connection between the upper end portion of the first upper link rod and the upper enclosure frame and the rotational connection between the upper end portion of the second upper link rod and the upper enclosure frame are located at different positions on the upper enclosure frame.

Further, the rotational connection between the upper end portion of the first upper link rod and the upper enclosure frame and the rotational connection between the upper end portion of the second upper link rod and the upper enclosure frame are located at the same height level on the upper enclosure frame.

In some embodiments, the rotational connection between the lower end portion of the first lower link rod and the underframe and the rotational connection between the lower end portion of the second lower link rod and the underframe are located at different positions on the underframe.

Further, the rotational connection between the lower end portion of the first lower link rod and the underframe and the rotational connection between the lower end portion of the second lower link rod and the underframe are located at the same height level on the underframe.

In some embodiments, the first linkage assembly and the second linkage assembly are symmetrically arranged between the underframe and the upper enclosure frame.

In some embodiments, the stroller further comprises a first limit structure for limiting the action of the folding mechanism when the upper enclosure frame is unfolded from a folded position to place the upper enclosure frame in an unfolded position, the first limit structure comprises first limit portions respectively arranged on either side of the underframe and second limit portions respectively arranged on either side of the upper enclosure frame, and when the upper enclosure frame is in the unfolded position, the first lower link rod and the second lower link rod respectively abut and cooperate with the first limit portions at corresponding positions, and the first upper link rod and the second upper link rod respectively abut and cooperate with the second limit portions at corresponding positions.

In some embodiments, the stroller further comprises a second limit structure for limiting the action of the folding mechanism when the upper enclosure frame is folded from an unfolded position to place the upper enclosure frame in a folded position, the second limit structure comprises third limit portions respectively arranged on either side of the underframe and fourth limit portions respectively arranged on either side of the upper enclosure frame, and when the upper enclosure frame is in the folded position, the first lower link rod and the second lower link rod respectively abut and cooperate with the third limit portions at corresponding positions, and the first upper link rod and the second upper link rod respectively abut and cooperate with the fourth limit portions at corresponding positions.

In some embodiments, the stroller further comprises a first folding mechanism arranged between a front end portion of the underframe and a front end portion of the upper enclosure frame and a second folding mechanism arranged between a rear end portion of the underframe and a rear end portion of the upper enclosure frame, and the first folding mechanism and the second folding mechanism are both the same as the folding mechanism.

In some embodiments, the upper enclosure frame does not deform when it performs upward or downward translational motion relative to the underframe.

Due to the use of the above technical solutions, the present disclosure has the following advantages over the conventional art: When folding or unfolding the stroller of the present disclosure, as long as the first linkage assembly and the second linkage assembly are moved, the upper enclosure frame can move downward to approach or move upward away from the underframe, thereby achieving the folding and unfolding operation of the upper enclosure frame. Moreover, when the upper enclosure frame is folded or unfolded, the first linkage assembly and the second linkage assembly can move synchronously, so that the upper enclosure frame can always maintain upward or downward translational motion without twisting, making the folding and unfolding actions of the upper enclosure frame smooth.

### BRIEF DESCRIPTION OF THE DRAWINGS

FIG. 1 is a schematic three-dimensional diagram of a stroller in an embodiment of the present disclosure when an upper enclosure frame is in an unfolded position;

FIG. 2 is a schematic rear view of the stroller in this embodiment of the present disclosure when the upper enclosure frame is in the unfolded position;

FIG. 3 is a schematic sectional view of the stroller in this embodiment of the present disclosure when the upper enclosure frame is in the unfolded position;

FIG. 4 is a schematic partial enlarged diagram of Part A in FIG. 3;

FIG. 5 is a schematic partial enlarged diagram of Part B in FIG. 3;

FIG. 6 is a schematic three-dimensional diagram of the stroller in this embodiment of the present disclosure when the upper enclosure frame is in a folded position;

FIG. 7 is a schematic rear view of the stroller in this embodiment of the present disclosure when the upper enclosure frame is in the folded position;

FIG. 8 is a schematic sectional view of the stroller in this embodiment of the present disclosure when the upper enclosure frame is in the folded position;

FIG. 9 is a schematic partial enlarged diagram of Part A in FIG. 8.

### DETAILED DESCRIPTION OF THE EXEMPLARY EMBODIMENTS

The technical solution of the present disclosure is further explained below combining with the accompanying drawings and specific embodiments.

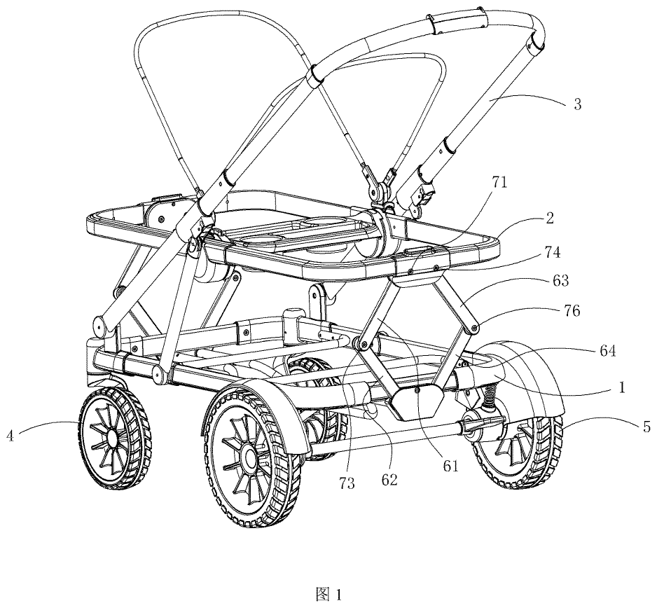

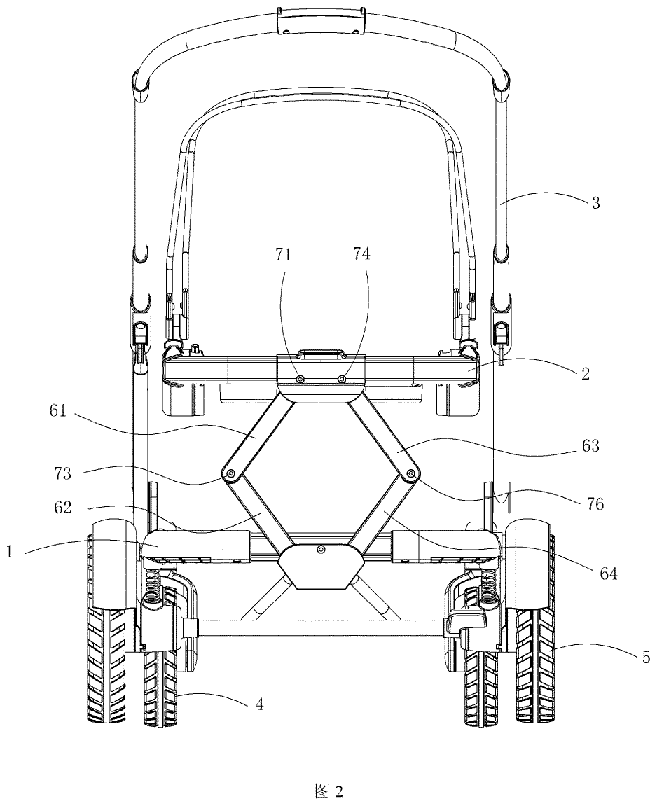

As shown in FIG. 1 ~FIG. 9, a stroller of the present disclosure comprises a underframe 1, an upper enclosure frame 2, and a push rod 3, the upper enclosure frame 2 is located above the underframe 1, and the push rod 3 is arranged on the underframe 1 for pushing or pulling the stroller. The stroller further comprises a front wheel assembly 4 located at the bottom front portion of the underframe 1 and a rear wheel assembly 5 located at the bottom rear of the underframe 1.

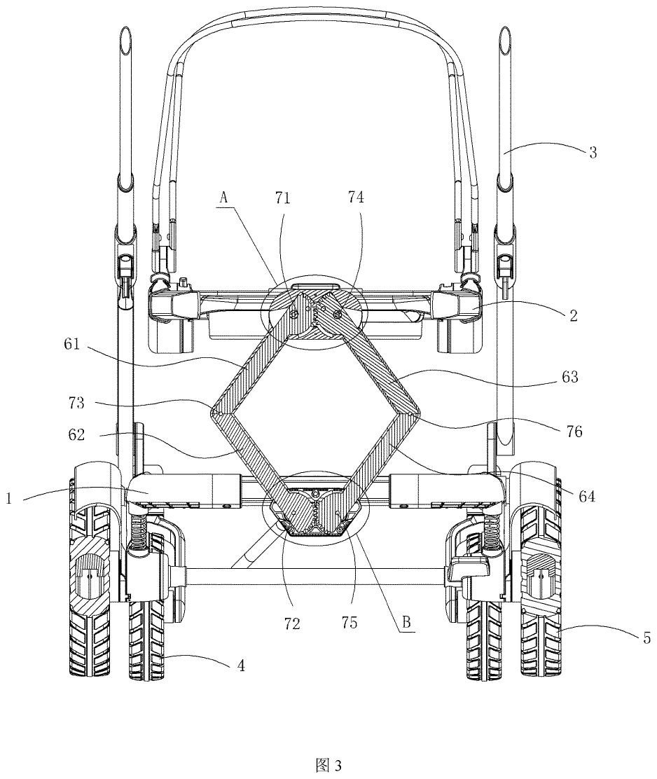

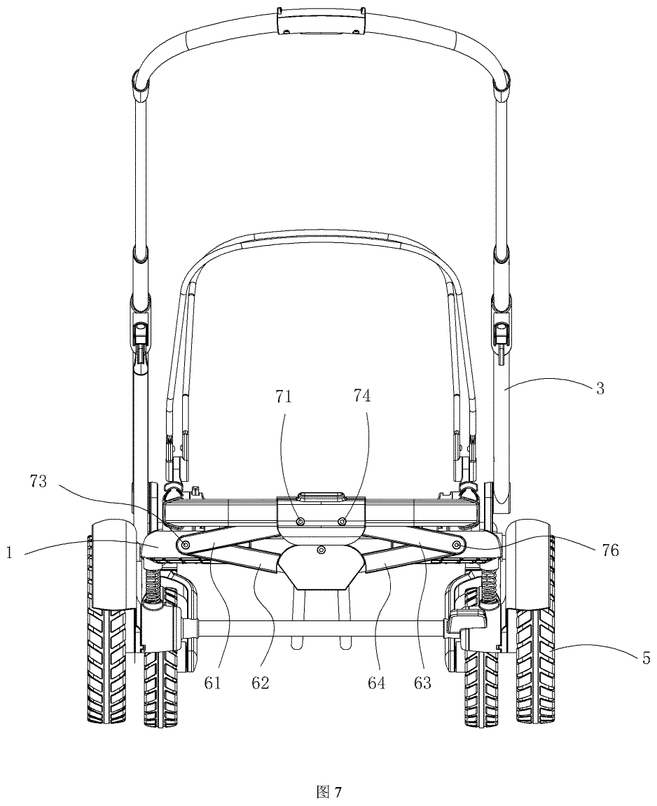

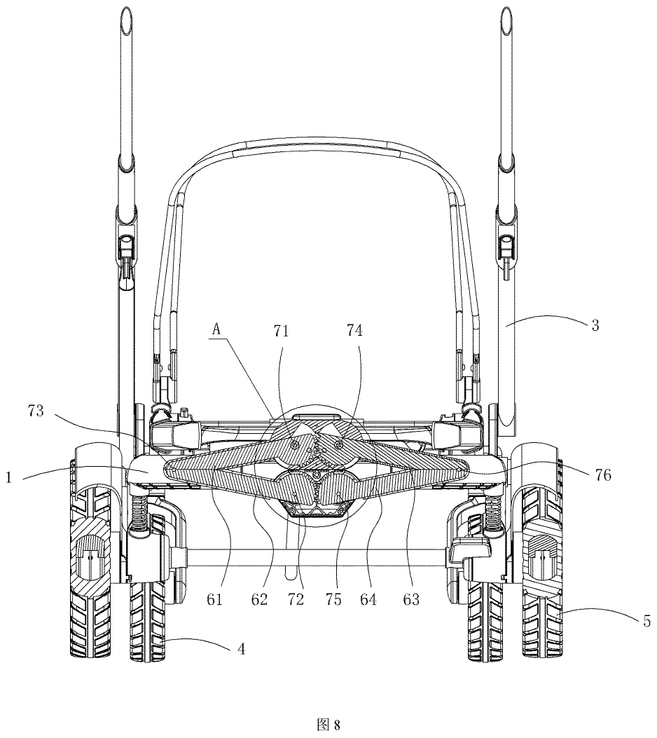

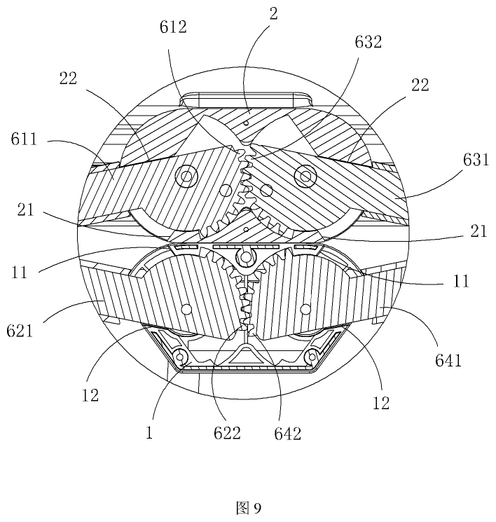

This stroller has an unfolded state and a folded state. When the stroller is in the unfolded state, the upper enclosure frame 2 is in an unfolded position, away from the underframe 1, forming a storage space between the underframe 1 and the upper enclosure frame 2, which is used for children to ride, lie down, or place items, as shown in FIG. 1~FIG. 3. When the stroller is in the folded state, the upper enclosure frame 2 is in a folded position, close to the underframe 1, as shown in FIG. 6~FIG. 8. The upper enclosure frame 2 is In some embodiments parallel to the underframe 1 in both the unfolded and folded positions. Both the upper enclosure frame 2 and the underframe 1 are made of rigid materials, which will not deform during the unfolding and folding process of the stroller.

The stroller further comprises a folding mechanism, which is connected between the underframe 1 and the upper enclosure frame 2. The folding mechanism is able to be unfolded and folded, the unfolding action of the folding mechanism can drive the upper enclosure frame 2 to be in the unfolded position, and the folding action of the folding mechanism can drive the upper enclosure frame 2 to be in the folded position. Specifically, the folding mechanism comprises a first linkage assembly and a second linkage assembly.

As shown in FIG. 1~FIG. 3 and FIG. 6~FIG. 8, the first linkage assembly comprises a first upper link rod 61 and a first lower link rod 62, wherein an upper end portion of the first upper link rod 61 is rotatably connected to the upper enclosure frame 2 via a first shaft 71, a lower end portion of the first lower link rod 61 is rotatably connected to the underframe 1 via a second shaft 72, and a lower end portion of the first upper link rod 61 is rotatably connected to an upper end portion of the first lower link rod 62 via a third shaft 73.

As shown in FIG. 1~FIG. 3 and FIG. 6~FIG. 8, the second linkage assembly comprises a second upper link rod 63 and a second lower link rod 64, wherein an upper end portion of the second upper link rod 63 is rotatably connected to the upper enclosure frame 2 via a fourth shaft 74, a lower end portion of the second lower link rod 63 is rotatably connected to the underframe 1 via a fifth shaft 75, and a lower end portion of the second upper link rod 63 is rotatably connected to an upper end portion of the second lower link rod 64 via a sixth shaft 76.

The first shaft 71 and the fourth shaft 74 are located at different positions on the upper enclosure frame 2, In some embodiments the first shaft 71 and the fourth shaft 74 are located at the same height level on the upper enclosure frame 2. The second shaft 72 and the fifth shaft 75 are located at different positions on the underframe 1, In some embodiments the second shaft 72 and the fifth shaft 75 are located at the same height level on the underframe 1.

The first shaft 71, the second shaft 72, the third shaft 73, the fourth shaft 74, the fifth shaft 75, and the sixth shaft 76 are arranged in parallel.

When the folding mechanism is in the unfolded state, the upper enclosure frame 2 is in the unfolded position, and at this time, the first upper link rod 61 is far away from the first lower link rod 62, forming a relatively large angle between them; the second upper link rod 63 is far away from the second lower link rod 64, forming a relatively large angle between them. When the folding mechanism is in the folded state, the upper enclosure frame 2 is in the folded position, and at this time, the first upper link rod 61 is close to the first lower link rod 62, forming a relatively small angle between them; the second upper link rod 63 is also close to the second lower link rod 64, forming a relatively small angle between them.

In some embodiments, the first linkage assembly and the second linkage assembly are symmetrically arranged between the underframe 1 and the upper enclosure frame 2.

The first linkage assembly cooperates with the second linkage assembly, such that when one of the first linkage assembly and the second linkage assembly moves, the other one thereof is driven to move synchronously, that is, when the first upper link rod 61 and the first lower link rod 62 are rotated relative to each other to approach each other, the second upper link rod 63 and the second lower link rod 64 are rotated relative to each other to approach each other synchronously; when the first upper link rod 61 and the first lower link rod 62 are rotated relative to each other to move away from each other, the second upper link rod 63 and the second lower link rod 64 are rotated relative to each other to move away from each other synchronously, which allows the upper enclosure frame 2 to always maintain a parallel state with the underframe 1 during folding or unfolding to perform upward or downward translational motion, without twisting.

In a specific implementation, the first upper link rod 61 and the second upper link rod 62 cooperate with each other, to achieve synchronous action of the first linkage assembly and the second linkage assembly.

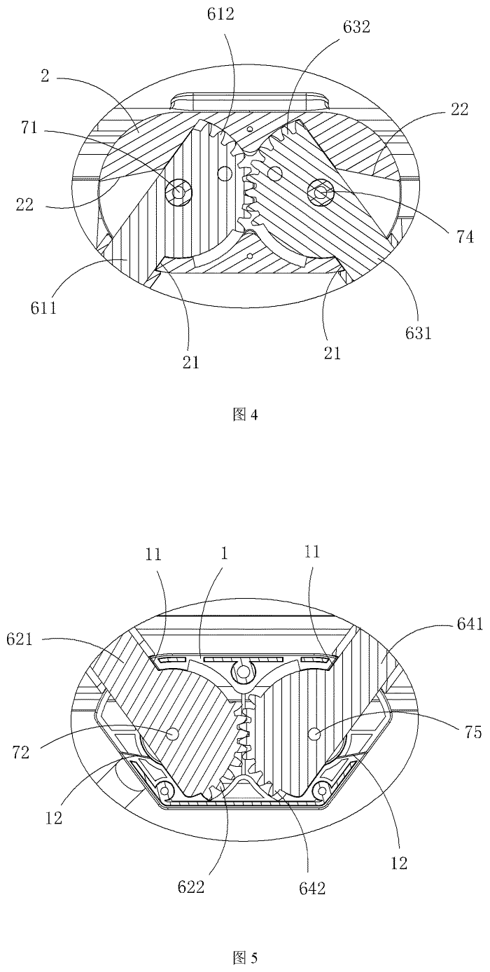

Specifically, the first upper link rod 61 comprises a first upper link rod 611 and a first gear 612 fixedly arranged on an upper end portion of the first upper rod body 611. The first gear 612 is rotatably connected to the upper enclosure frame 2 via the first shaft 71, and a lower end portion of the first upper rod body 611 is rotatably connected to the upper end portion of the first lower link rod 62 via the third shaft 73. The second upper link rod 63 comprises a second upper link rod 631 and a second gear 632 fixedly arranged on an upper end portion of the second upper rod body 631. The second gear 632 is rotatably connected to the upper enclosure frame 2 via the fourth shaft 74, a lower end portion of the second upper rod body 631 is rotatably connected to the upper end portion of the second lower link rod 64 via the six shaft 76, and the first gear 612 meshes with the second gear 632, as shown in FIG. 3 and FIG. 4.

When the first upper link rod 61 is rotated relative to the first lower link rod 62, the first gear 612 is rotated relative to the upper enclosure frame 2, and the meshing of the first gear 612 and the second gear 632 can cause the second gear 632 to rotate relative to the upper enclosure frame 2, causing the second upper link rod 63 and the second lower link rod 64 to rotate relative to each other. Conversely, when the second upper link rod 63 is rotated relative to the second lower link rod 64, the meshing of the first gear 612 and the second gear 632 can cause the first upper link rod 61 to synchronously rotate relative to the first lower link rod 62, thereby achieving the synchronous action of the first linkage mechanism and the second linkage mechanism.

In another specific implementation, it also may let the first lower link rod 62 and the second lower link rod 64 cooperate with each other, thereby achieving synchronous action of the first linkage assembly and the second linkage assembly.

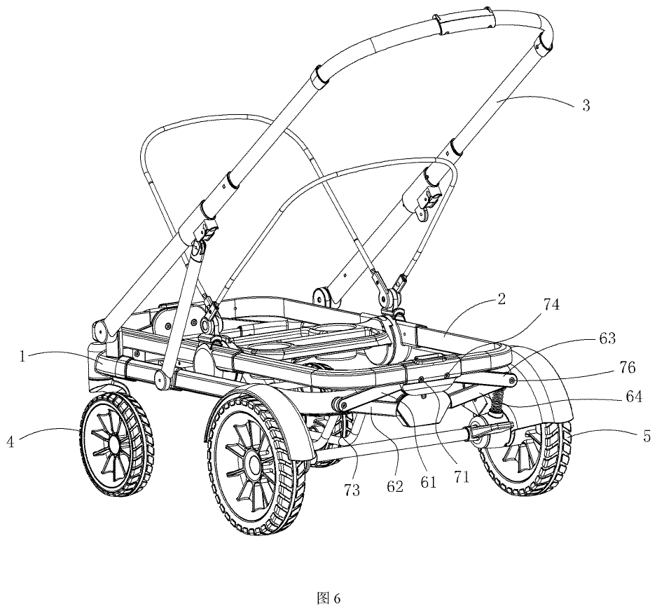

Specifically, the first lower link rod 62 comprises a first lower link rod 621 and a third gear 622 fixedly arranged on a lower end portion of the first lower rod body 621. The third gear 622 is rotatably connected to the underframe 1 via the second shaft 72, and an upper end portion of the first lower rod body 621 is rotatably connected to the lower end portion of the first upper link rod 61 via the third shaft 73. The second lower link rod 64 comprises a second lower rod body 641 and a fourth gear 642 fixedly arranged at a lower end portion of the second lower rod body 641, the fourth gear 642 is rotatably connected to the underframe 1 via the fifth shaft 75, an upper end portion of the second lower rod body 641 is rotatably connected to the lower end portion of the second upper link rod 63 via the sixth shaft 76, and the third gear 622 meshes with the fourth gear 642, as shown in FIG. 3 and FIG. 5.

When the first upper link rod 61 is rotated relative to the first lower link rod 62, the third gear 622 is rotated relative to the underframe 1, and the meshing of the third gear 622 and the fourth gear 642 can cause the fourth gear 642 to rotate relative to the underframe 1, causing the second upper link rod 63 and the second lower link rod 64 to rotate relative to each other. Conversely, when the second upper link rod 63 is rotated relative to the second lower link rod 64, the meshing of the third gear 622 and the fourth gear 642 can cause the first upper link rod 61 to synchronously rotate relative to the first lower link rod 62, thereby achieving the synchronous action of the first linkage mechanism and the second linkage mechanism.

Of course, the above two implementations may also be used at the same time, that is, the upper end portions of the first upper link rod 61 and the second upper link rod 63 mesh with the second gear 632 via the first gear 612, and the lower end portions of the first lower link rod 62 and the second lower link rod 64 mesh with the fourth gear 642 via the third gear 622. In this way, while achieving synchronous action between the first linkage assembly and the second linkage assembly to always maintain the upward or downward translational motion of the upper enclosure frame 2, the structure of the locking mechanism for locking the upper enclosure frame 2 in the unfolded position of the stroller is also simplified, and it only needs to lock the positions of the two interconnected components of the upper enclosure frame 2, the first upper link rod 61, the first lower link rod 62, the underframe 1, the second lower link rod 64 and the second upper link rod 63.

The stroller further comprises a first limit structure, and when the upper enclosure frame 2 is unfolded from the folded position, the action of the folding mechanism can be limited by the first limit structure to keep the upper enclosure frame 2 in the unfolded position.

Specifically, as shown in FIG. 3~FIG. 5, the first limit structure comprises first limit portions 11 arranged on the underframe 1 and second limit portions 21 arranged on the upper enclosure frame 2, the first limit portions 11 are respectively arranged on either side of the underframe 1, and the second limit portions 21 are respectively arranged on either side of the upper enclosure frame 2. When the upper enclosure frame 2 is in the unfolded position, the first lower link rod 62 and the second lower link rod 64 respectively abut and cooperate with the first limit portions 11 at corresponding positions, and the first upper link rod 61 and the second upper link rod 63 respectively abut and cooperate with the second limit portions 21 at corresponding positions.

The stroller further comprises a second limit structure, and when the upper enclosure frame 2 is folded from the unfolded position, the action of the folding mechanism can be limited by the second limit structure to keep the upper enclosure frame 2 in the folded position.

Specifically, as shown in FIG. 8 and FIG. 9, the second limit structure comprises third limit portions 12 arranged on the underframe 1 and fourth limit portions 22 arranged on the upper enclosure frame 2, the third limit portions 12 are respectively arranged on either side of the underframe 1, and the fourth limit portions 22 are respectively arranged on either side of the upper enclosure frame 2. When the upper enclosure frame 2 is in the folded position, the first lower link rod 62 and the second lower link rod 64 respectively abut and cooperate with the third limit portions 12 at corresponding positions, and the first upper link rod 61 and the second upper link rod 63 respectively abut and cooperate with the fourth limit portions 22 at corresponding positions.

In this embodiment, the folding mechanism is arranged between the front end portion of the underframe 1 and the front end portion of the upper enclosure frame 2, which defines a first folding mechanism. The folding mechanism is further arranged between the rear end portion of the underframe 1 and the rear end portion of the upper enclosure frame 2, which defines a second folding mechanism.

When the upper enclosure frame 2 transitions from the unfolded position to the folded position, the locking mechanism is unlocked, and the upper enclosure frame 2 is pressed downwards, in both the first folding mechanism and the second folding mechanism, the meshing of the first gear 612 and the second gear 632 and the meshing of the third gear 622 and the fourth gear 642, cause the first upper link rod 61 and the first lower link rod 62 to rotate relative to each other and approach each other, and the second upper link rod 63 and the second lower link rod 64 also to rotate relative to each other and approach each other synchronously, so that the upper enclosure frame 2 remains parallel to the underframe 1 and performs the downward translational motion to approach the underframe 1, until the first lower link rod 62 and the second lower link rod 64 respectively abut and cooperate with the third limit portions 12 at the corresponding positions on the underframe 1, the first upper link rod 61 and the second upper link rod 63 respectively abut and cooperate with the fourth limit portions 22 at the corresponding positions on the upper enclosure frame 2, the first upper link rod 61 and the first lower link rod 62 cannot continue to rotate relative to each other in the current direction, and the second upper link rod 63 and the second lower link rod 64 cannot continue to rotate relative to each other in the current direction, then the upper enclosure frame 2 is in the folded position, as shown in FIG. 6~FIG. 8.

When the upper enclosure frame 2 is in the folded position, the push rod 3 is close to the underframe 1, and the stroller is in the folded state.

When the upper enclosure frame 2 is unfolded from the folded position, after the push rod 3 moves in reverse to the unfolded position, the upper enclosure frame 2 is pulled upwards, in both the first folding mechanism and the second folding mechanism, the meshing of the first gear 612 and the second gear 632 and the meshing of the third gear 622 and the fourth gear 642, cause the first upper link rod 61 and the first lower link rod 62 to rotate relative to each other to move away from each other, and the second upper link rod 63 and the second lower link rod 64 also to rotate relative to each other to move away from each other synchronously, so that the upper enclosure frame 2 remains parallel to the underframe 1 and performs the upward translational motion to move away from the underframe 1, until the first lower link rod 62 and the second lower link rod 64 respectively abut and cooperate with the first limit portions 11 at the corresponding positions on the underframe 1, the first upper link rod 61 and the second upper link rod 63 respectively abut and cooperate with the second limit portions 21 at the corresponding positions on the upper enclosure frame 2, the first upper link rod 61 and the first lower link rod 62 cannot continue to rotate relative to each other in the current direction, and the second upper link rod 63 and the second lower link rod 64 cannot continue to rotate relative to each other in the current direction, then the upper enclosure frame 2 is in the unfolded position, as shown in FIG. 1~FIG. 3.

The embodiments described above are only for illustrating the technical concepts and features of the present disclosure, and are intended to make those skilled in the art being able to understand the present disclosure and thereby implement it, and should not be concluded to limit the protective scope of the present disclosure. Any equivalent variations or modifications according to the spirit of the present disclosure should be covered by the protective scope of the present disclosure.

What is claimed is:

1. A stroller comprising an underframe and an upper enclosure frame located above the underframe, wherein the stroller further comprises a folding mechanism arranged between the underframe and the upper enclosure frame and used for driving the upper enclosure frame to move closer to or away from the underframe, the folding mechanism comprises a first linkage assembly and a second linkage assembly, the first linkage assembly comprises a first upper link rod and a first lower link rod, wherein an upper end portion of the first upper link rod is rotatably connected to the upper enclosure frame, a lower end portion of the first lower link rod is rotatably connected to the underframe, and a lower end portion of the first upper link rod is rotatably connected to an upper end portion of the first lower link rod, the second linkage assembly comprises a second upper link rod and a second lower link rod, wherein an upper end portion of the second upper link rod is rotatably connected to the upper enclosure frame, a lower end portion of the second lower link rod is rotatably connected to the underframe, and a lower end portion of the second upper link rod is rotatably connected to an upper end portion of the second lower link rod, the first linkage assembly cooperates with the second linkage assembly, and when one of the first linkage assembly and the second linkage assembly moves, the other one thereof is driven to move synchronously, such that the upper enclosure frame performs upward or downward translational motion relative to the underframe.

2. The stroller according to claim 1, wherein the first upper link rod cooperates with the second upper link rod.

3. The stroller according to claim 2, wherein the first upper link rod comprises a first upper rod body and a first gear fixedly arranged at an upper end portion of the first upper rod body, the first gear is rotatably connected to the upper enclosure frame, a lower end portion of the first upper rod body is rotatably connected to the upper end portion of the first lower link rod, the second upper link rod comprises a second upper rod body and a second gear fixedly arranged at an upper end portion of the second upper rod body, the second gear is rotatably connected to the upper enclosure frame, a lower end portion of the second upper rod body is rotatably connected to the upper end portion of the second lower link rod, and the first gear meshes with the second gear.

4. The stroller according to claim 1, wherein the first lower link rod cooperates with the second lower link rod.

5. The stroller according to claim 4, wherein the first lower link rod comprises a first lower rod body and a third gear fixedly arranged at a lower end portion of the first lower rod body, the third gear is rotatably connected to the underframe, an upper end portion of the first lower rod body is rotatably connected to the lower end portion of the first upper link rod, the second lower link rod comprises a second lower rod body and a fourth gear fixedly arranged at a lower end portion of the second lower rod body, the fourth gear is rotatably connected to the underframe, an upper end portion of the second lower rod body is rotatably connected to the lower end portion of the second upper link rod, and the third gear meshes with the fourth gear.

6. The stroller according to claim 1, wherein the first upper link rod cooperates with the second upper link rod, and the first lower link rod cooperates with the second lower link rod.

7. The stroller according to claim 6, wherein the first upper link rod comprises a first upper rod body and a first gear fixedly arranged at an upper end portion of the first upper rod body, the second upper link rod comprises a second upper rod body and a second gear fixedly arranged at an upper end portion of the second upper rod body, the first lower link rod comprises a first lower rod body and a third gear fixedly arranged at a lower end portion of the first lower rod body, the second lower link rod comprises a second lower rod body and a fourth gear fixedly arranged at a lower end portion of the second lower rod body, both the first gear and the second gear are rotatably connected to the upper enclosure frame, both the third gear and the fourth gear are rotatably connected to the underframe, a lower end portion of the first upper rod body is rotatably connected to an upper end portion of the first lower rod body, a lower end portion of the second upper rod body is rotatably connected to an upper end portion of the second lower rod body, the first gear meshes with the second gear, and the third gear meshes with the fourth gear.

8. The stroller according to claim 1, wherein the rotational connection between the upper end portion of the first upper link rod and the upper enclosure frame and the rotational connection between the upper end portion of the second upper link rod and the upper enclosure frame are located at different positions on the upper enclosure frame.

9. The stroller according to claim 8, wherein the rotational connection between the upper end portion of the first upper link rod and the upper enclosure frame and the rotational connection between the upper end portion of the second upper link rod and the upper enclosure frame are located at the same height level on the upper enclosure frame.

10. The stroller according to claim 1, wherein the rotational connection between the lower end portion of the first lower link rod and the underframe and the rotational connection between the lower end portion of the second lower link rod and the underframe are located at different positions on the underframe.

11. The stroller according to claim 10, wherein the rotational connection between the lower end portion of the first lower link rod and the underframe and the rotational connection between the lower end portion of the second lower link rod and the underframe are located at the same height level on the underframe.

12. The stroller according to claim 1, wherein the first linkage assembly and the second linkage assembly are symmetrically arranged between the underframe and the upper enclosure frame.

13. The stroller according to claim 1, wherein the stroller further comprises a first limit structure for limiting the action of the folding mechanism when the upper enclosure frame is unfolded from a folded position to place the upper enclosure frame in an unfolded position, the first limit structure comprises first limit portions respectively arranged on either side of the underframe and second limit portions respectively arranged on either side of the upper enclosure frame, and when the upper enclosure frame is in the unfolded position, the first lower link rod and the second lower link rod respectively abut and cooperate with the first limit portions at corresponding positions, and the first upper link rod and the second upper link rod respectively abut and cooperate with the second limit portions at corresponding positions.

14. The stroller according to claim 1, wherein the stroller further comprises a second limit structure for limiting the action of the folding mechanism when the upper enclosure frame is folded from an unfolded position to place the upper enclosure frame in a folded position, the second limit structure comprises third limit portions respectively arranged on either side of the underframe and fourth limit portions respectively arranged on either side of the upper enclosure frame, and when the upper enclosure frame is in the folded position, the first lower link rod and the second lower link rod respectively abut and cooperate with the third limit portions at corresponding positions, and the first upper link rod and the second upper link rod respectively abut and cooperate with the fourth limit portions at corresponding positions.

15. The stroller according to claim 1, wherein the stroller further comprises a first folding mechanism arranged between a front end portion of the underframe and a front end portion of the upper enclosure frame and a second folding mechanism arranged between a rear end portion of the underframe and a rear end portion of the upper enclosure frame, and the first folding mechanism and the second folding mechanism are both the same as the folding mechanism.

16. The stroller according to claim 1, wherein the upper enclosure frame does not deform when it performs upward or downward translational motion relative to the underframe.
